(19) United States
(12) Patent Application Publication
(10) Pub. No.: US 2013/0168373 A1
(43) Pub. Date: Jul. 4, 2013

(54) LASER CUTTING PLOTTER

(71) Applicant: Heng-Kuan Lin, New Taipei City (TW)

(72) Inventor: Heng-Kuan Lin, New Taipei City (TW)

(21) Appl. No.: 13/338,918

(22) Filed: Dec. 28, 2011

(51) Int. Cl. B23K 26/02

(52) U.S. Cl. 219/121.82

(57) ABSTRACT

A laser cutting plotter comprises a machine body. The machine body is provided with a first track for being connected with a slidable table. The slidable table is connected with a driving device for moving the slidable table, so that the slidable table is horizontally movable along one axis relative to the machine body. A second track has two ends connected to the machine body and is located above the first track. Besides, the second track is perpendicular to the first track. Moreover, the second track is connected with a mirror seat that is horizontally movable along the second track. Thereby, the mirror seat is movable on one horizontal plane by means of a controller and is provided with a laser tube used to emit laser beams downwards from the mirror seat for cutting objects.

### TECHNICAL FIELD

The present invention relates to a laser cutting plotter, which has simple structure and is able to elevate the degree of precision for laser procession.

### BACKGROUND

For performing the cutting irregular patterns for various kinds of plates, conventionally used cutting plotters usually comprise a cutting seat provided with a vertically extensible cutter. The cutter is disposed on a horizontal sliding track and the two ends of the horizontal sliding track are respectively disposed on a track that is perpendicular to that horizontal sliding track. A plurality of upright supports or a rectangular frame is located below the two tracks in order to uphold the tracks. Thereby, when a plate is positioned below the cutter, it is able to cut the plate by moving the cutter vertically via the control of a computer control mechanism and by moving the cutting seat along the horizontal sliding track and the tracks that are perpendicular to each other.

As mentioned above, the cutter, the horizontal sliding track, and the two tracks are upheld by the plurality of upright supports or the rectangular frame. Accordingly, the support forces are upon only several points or on the same plane. Therefore, the supports or the frame must be thick or heavy in order to provide support sufficient for the cutter to perform cutting operation smoothly and precisely. However, in this way, the supports or the frame has increased cost of material and may occupy more space.

Moreover, when a cutter is used for cutting patterns, it is required to move the cutter three-dimensionally. Therefore, more components are necessary to control the movement of the cutter. Besides, in this case, it is more difficult to control the cutter precisely and may fail to meet the requirements of refined procession.

In order to overcome above shortcomings, inventor had the motive to study and develop the present invention having a structure that is distinguished from conventional one. After hard research and development, the inventor provides a laser cutting plotter that has lower production cost, is of more compact size, and has elevated precision for procession.

### SUMMARY OF THE DISCLOSURE

An object of the present invention is to provide a laser cutting plotter using one track to support a mirror seat and another track to support a slidable table, so as to make the mirror seat movable along one horizontal plane to perform the cutting operation of patterns directly for the objects located below the mirror seat. Thereby, the support structure is simplified, the production cost is cut down, and the precision for procession is elevated.

Another object of the present invention is to provide a laser cutting plotter that has simplified support structure and more compact size, and is conveniently movable.

In order to achieve above objects, the present invention provides a laser cutting plotter comprising a machine body, a slidable table, a second track, a mirror seat, a laser tube, and a controller. The machine body is provided with a first track and a driving device. The slidable table is connected to the first track and is connected with the driving device, so that the slidable table is horizontally movable along one axis relative to the machine body. The second track has two ends connected to the machine body and the second track is perpendicular to the first track and is located above the first track. The mirror seat is connected to the second track in a way of being horizontally movable and the mirror seat is able to emit laser beams downwards via the laser tube. The laser tube is connected with the controller that is used to control the laser beams from the laser tube for cutting objects.

In implementation, the first track includes a left long support block provided at the machine body's left side and a right long support block provided at the machine body's right side. The slidable table includes a body, a left protrusion protruding leftwards from the body's left side, and a right protrusion protruding rightwards from the body's right side. The left protrusion is located above the left long support block while the right protrusion is located above the right long support block.

In implementation, a rack is provided between the body's right side and the right protrusion of the slidable table; the driving device includes a servomotor and a gear wheel connected to the servomotor; and the gear wheel is engaged with the rack.

The following detailed description, given by way of examples or embodiments, will best be understood in conjunction with the accompanying drawings.

### BRIEF DESCRIPTION OF THE DRAWINGS

FIG. 1 shows a front cross-sectional view of a preferred embodiment of the present invention.

FIG. 2 shows a lateral view of the preferred embodiment of the present invention where a right lateral plate is removed.

FIGS. 3 and 4 show the use of the preferred embodiment of the present invention.

### DETAILED DESCRIPTION

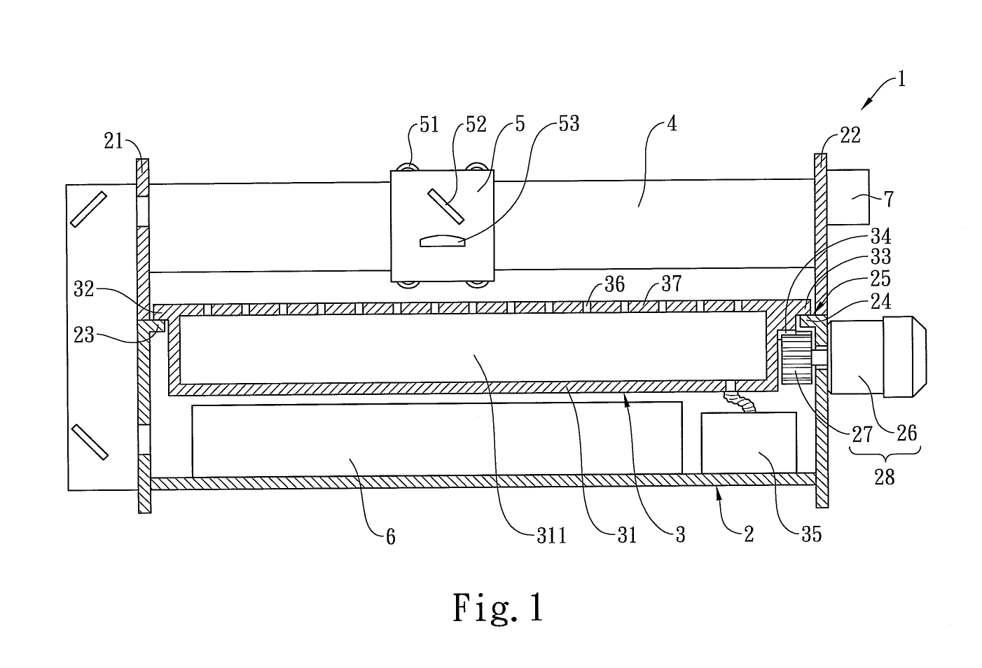

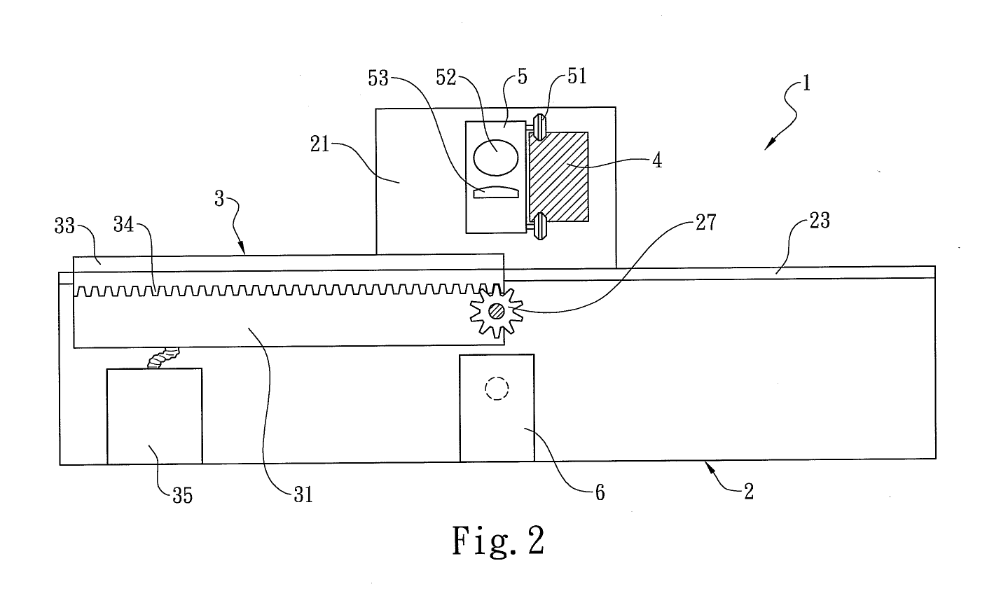

Please refer to FIGS. 1 and 2, where a preferred embodiment of a laser cutting plotter 1 of the present invention is illustrated and the laser cutting plotter 1 comprises a machine body 2, a slidable table 3, a second track 4, a mirror seat 5, a laser tube 6, and a controller 7.

The machine body 2 is roughly in rectangular shape and is provided with a left lateral plate 21 at the left side of the machine body 2 and a right lateral plate 22 at the right side of the machine plate 2. A left long support block 23 is provided at the middle position on the right lateral surface of the left lateral plate 21. The left long support block 23 is extended horizontally from the machine body's front end to its rear end. A right long support block 24 is provided at the middle position on the left lateral surface of the right lateral plate 22. The right long support block 24 is extended horizontally from the machine body's front end to its rear end. Besides, the left and right long support blocks 23, 24 are disposed symmetrically at the two sides of the machine body 2. The left and right long support blocks 23, 24 form a first track 25. Moreover, a servomotor 26 is located on the right lateral plate 22 of the machine body 2. The servomotor 26 is connected with the controller 7 and the left end of the spindle of the servomotor 26 is connected with a gear wheel 27. The gear wheel 27 and the servomotor 26 form a driving device 28.

The slidable table 3 includes a body 31, a left protrusion 32, a right protrusion 33, and a rack 34. The body 31 is a rectangular flat plate and a space 311 is formed therein. The space 311 is in communication with one end of an air-extraction device 35. The top of the body 31 has a plurality of holes 36 through which the space outside the slidable table 3 is in communication with the space 311. By means of the arrangement of the holes 36, the top forms a meshed plate 37. In practice, the holes 36 also can be in long-strip shape and plural long-strip holes 36 can be arranged on the same top surface.

The left protrusion 32 protrudes leftwards from the left side of the body 31 while the right protrusion 33 protrudes rightwards from the right side of the body 31. The left protrusion 32 is located above the left long support block 23 while the right protrusion 33 is located above the right long support block 24. The rack 34 is disposed between the right side of the body 31 and the right protrusion 33. Besides, the rack 34 is engaged with the gear wheel 27 of the driving device 28.

The second track 4 is in long-strip shape and has two ends respectively connected to the left lateral plate 21 and the right lateral plate 22 of the machine body 2. The second track 4 is perpendicular to the first track 25 and the second track 4 is located above the first track 25.

The mirror seat 5 is connected with the controller 7. The mirror seat 5 is provided with a plurality of rollers 51 at one side thereof, so that the mirror seat 5 is horizontally movable along the second track 4 when being connected to the second track 4. In practice, one side of the mirror seat 5 and the second track 4 can be respectively provided with a plurality of dovetail-shape tracks corresponding to each other. By this way, the mirror seat 5 is also horizontally movable along the second track 4. Moreover, the laser tube 6 is located within the machine body 2 and the laser tube 6 is connected with the controller 7, so that the controller is able to have the laser tube 6 emit laser beams. After the laser beams are emitted, the laser beams will travel downwards from the bottom of the mirror seat 5 by means of reflection and focusing respectively performed by a reflection mirror 52 and a focusing mirror 53 that are located in the mirror seat 5.

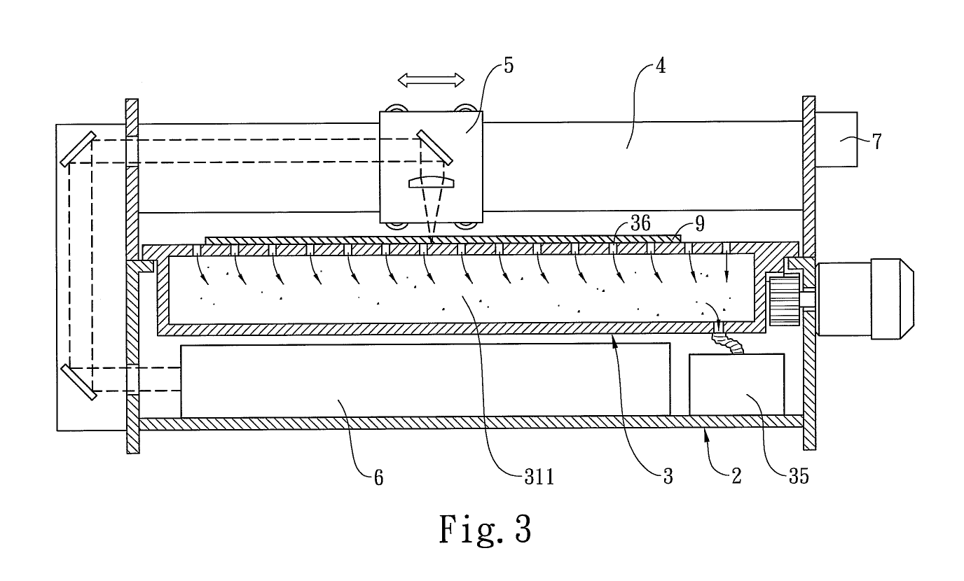

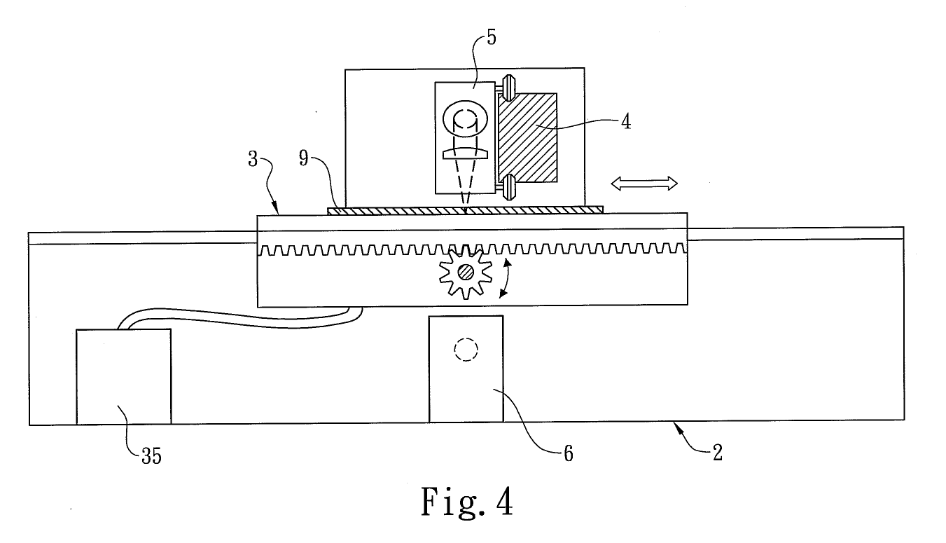

Thereby, as shown in FIGS. 3 and 4, when a flat object 9 is placed on the top of the slidable table 3, the flat object 9 can be firmly attached to the top of the slidable table 3 by means of negative pressure generated by the expiration of the air-expiration device 35. Via the control of the controller 7, the mirror seat 5 is horizontally movable along one axis on the second track 4 and the slidable table 5 is horizontally movable along another axis relative to the machine body 2. In this way, the mirror seat 5 can be moved to any one horizontal location above the flat object 9 to emit laser beams via the laser tube 6 controlled by the controller 7 for cutting patterns of the flat object 9. The cut residues drop into the space 311 via the holes 36 on the top of the slidable table 3.

Therefore, the present invention has following advantages:

1. According to the present invention, the mirror seat and the slidable table are upheld respectively by different tracks and thus the support forces can be scattered unto the upper and middle positions of the left and right lateral plates. Thereby, it is able to have the support forces distributed, to simplify the structure, to make the size compact, and to reduce the material cost.
2. According to the present invention, the mirror seat is movable along one horizontal plane to perform the cutting operation of patterns directly for the objects located below the mirror seat. Thereby, it is able to simplify the structure used for moving vertically a cutter, to cut down the production cost, and to elevate the precision for procession.

As disclosed in the above description and attached drawings, the present invention can provide a laser cutting plotter that has simple structure so as to reduce the cost, has more compact size, and is able to elevate the degree of precision for laser procession. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A laser cutting plotter, comprising:
a machine body, provided with a first track and a driving device;
a slidable table, connected to the first track and connected with the driving device, so that the slidable table is horizontally movable along one axis relative to the machine body;
a second track, having two ends connected to the machine body and being perpendicular to the first track and located above the first track; and
a mirror seat, connected to the second track in a way of being horizontally movable, where the mirror seat is provided with a laser tube for emitting laser beams downwards and the laser tube is connected with a controller that is used to control the laser beams from the laser tube for cutting objects.

2. The laser cutting plotter as claimed in claim 1, wherein the first track includes a left long support block provided at the machine body's left side and a right long support block provided at the machine body's right side; the slidable table includes a body, a left protrusion protruding leftwards from the body's left side, and a right protrusion protruding rightwards from the body's right side; and the left protrusion is located above the left long support block while the right protrusion is located above the right long support block.

3. The laser cutting plotter as claimed in claim 2, wherein a rack is provided between the body's right side and the right protrusion of the slidable table; the driving device includes a servomotor and a gear wheel connected to the servomotor; and the gear wheel is engaged with the rack.

4. The laser cutting plotter as claimed in claim 2, wherein a space is formed in the slidable table and the slidable table's top is provided with a plurality holes through which the space of slidable table is in communication with outside space.

5. The laser cutting plotter as claimed in claim 4, wherein the slidable table's top is a meshed plate.

6. The laser cutting plotter as claimed in claim 4 further comprising an air-extraction device, wherein one end of the air-extraction device is in communication with the space within the slidable table.

7. The laser cutting plotter as claimed in claim 1, wherein a space is formed in the slidable table and the slidable table's top is provided with a plurality holes through which the space of slidable table is in communication with outside space.

8. The laser cutting plotter as claimed in claim 7, wherein the slidable table's top is a meshed plate.

9. The laser cutting plotter as claimed in claim 7 further comprising an air-extraction device, wherein one end of the air-extraction device is in communication with the space within the slidable table.
